(19) United States
(12) Patent Application Publication
(10) Pub. No.: US 2008/0246719 A1
(43) Pub. Date: Oct. 9, 2008

(54) GRADATION VOLTAGE SELECTION CIRCUIT AND DISPLAY CONTROL CIRCUIT

(75) Inventor: Yumiko Mizuta, Kamakura-Shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/062,027

(22) Filed: Apr. 3, 2008

(30) Foreign Application Priority Data
Apr. 4, 2007 (JP) 2007-98286

(51) Int. Cl. G09G 3/36

(52) U.S. Cl. 345/95

(57) ABSTRACT

A gradation voltage selection circuit has a plurality of gradation selection parts, a plurality of tournament circuits, and a decoder circuit. Each of the plurality of gradation selection parts includes two first switch circuits and a second switch circuit. The tournament circuit repeating operations of selecting one of two gradation selection voltages based on a logic of partial bits except for bits of the gradation selection signal used for selection operations of the first and second switch circuits, and the decoder circuit selecting one of the plurality of gradation voltages output from the tournament circuit based on a result of decoding bits except for bits of the gradation selection signal used for selection operations of the first switch circuit, second switch circuit and tournament circuit, and supplying the selected one to the output wiring line.

### CROSS REFERENCE TO RELATED APPLICATIONS

This application is based upon claims the benefit of priority from the prior Japanese Patent Application No. 2007-98286, filed on Apr. 4, 2007, the entire contents of which are incorporated herein by reference.

### BACKGROUND OF THE INVENTION

1. Field of the Invention

The present invention relates to a gradation voltage selection circuit for selecting one of a plurality of gradation voltages based on the logic of a gradation selection signal, and to a display control circuit having the gradation voltage selection circuit.

2. Related Art

In liquid crystal displays, gradation voltage selection circuits have been used conventionally. In this kind of conventional gradation voltage selection circuit, odd or even gradation voltage wiring lines are selected in a lower bit of a gradation selection signal, and any one of the selected gradation voltage wiring lines is selected based on the result of decoding a higher bit (refer to Japanese Patent Laid Open (kokai) 2001-133754).

In this gradation voltage selection circuit of the above document, the gradation voltage wiring lines are selected in the lower bit of the gradation selection signal, so that the number of transistors arranged in a row direction can be reduced. However, as to the higher bit of the gradation selection signal, a signal is selected by decode processing, and there is thus a problem that the area of a decoder circuit increases as the number of bits of the gradation selection signal increases.

The gradation voltage selection circuit is often formed in a chip of, for example, an LCD driver, and in order to reduce the size of the chip, the size of the decoder circuit has to be reduced. In order to reduce the size of the decoder circuit, it may be assumed to reduce the channel width of the transistors constituting the decoder circuit.

However, if the channel width is reduced, a current Ids running across a drain and a source decreases, and the on-resistance of the transistor increases, such that switching operation becomes slower and a desired electric characteristic cannot be obtained.

### SUMMARY OF THE INVENTION

According to one aspect of the present invention, a gradation voltage selection circuit, comprising:

a plurality of gradation selection parts configured to select one of four kinds of gradation voltages, respectively;

a plurality of tournament circuits configured to repeat operations of selecting one of two gradation voltages selected by the gradation selection parts to select one gradation voltage, respectively; and

a decoder circuit configured to select one of the plurality of gradation voltages selected by the plurality of tournament circuits and to supply the selected one to an output wiring line,

each of the plurality of gradation selection parts including:

two first switch circuits configured to select one of two kinds of gradation voltages based on the least significant bit of a gradation selection signal; and

a second switch circuit configured to select one of outputs of the two first switch circuits in accordance with a logic of the most significant bit or the second least significant bit of the gradation selection signal and to supply the selected one to the tournament circuit,

the tournament circuit repeating operations of selecting one of two gradation selection voltages based on a logic of partial bits except for bits of the gradation selection signal used for selection operations of the first and second switch circuits; and

the decoder circuit selecting one of the plurality of gradation voltages output from the tournament circuit based on a result of decoding bits except for bits of the gradation selection signal used for selection operations of the first switch circuit, second switch circuit and tournament circuit, and supplying the selected one to the output wiring line.

Furthermore, according to the other aspect of the present invention, a display control circuit, comprising:

a positive gradation voltage selection circuit configured to generate a positive gradation voltage;

a negative gradation voltage selection circuit configured to generate a negative gradation voltage;

a polarity changing circuit configured to select one of the positive gradation voltage and negative gradation voltage; and

an output circuit configured to adjust a gain of the gradation voltage selected by the polarity changing circuit and supply the adjusted voltage to the corresponding signal line,

each of the positive polarity gradation voltage selection circuit and negative gradation voltage selection circuit including:

a plurality of gradation selection parts configured to select one of four kinds of gradation voltages, respectively;

a plurality of tournament circuits configured to repeat operations of selecting one of two gradation voltages selected by the gradation selection parts to select one gradation voltage, respectively; and

a decoder circuit configured to select one of the plurality of gradation voltages selected by the plurality of tournament circuits and to supply the selected one to an output wiring line,

each of the plurality of gradation selection parts including:

two first switch circuits configured to select one of two kinds of gradation voltages based on the least significant bit of a gradation selection signal; and

a second switch circuit configured to select one of outputs of the two first switch circuits in accordance with a logic of the most significant bit or the second least significant bit of the gradation selection signal and to supply the selected one to the tournament circuit,

the tournament circuit repeating operations of selecting one of two gradation selection voltages based on a logic of partial bits except for bits of the gradation selection signal used for selection operations of the first and second switch circuits; and

the decoder circuit selecting one of the plurality of gradation voltages output from the tournament circuit based on a result of decoding bits except for bits of the gradation selection signal used for selection operations of the first switch circuit, second switch circuit and tournament circuit, and supplying the selected one to the output wiring line.

### BRIEF DESCRIPTION OF THE DRAWINGS

FIG. 1 is a circuit diagram of a gradation voltage selection circuit according to a first embodiment of the present invention;

FIG. 2 is a block diagram showing one example of the internal configuration of an LCD driver;

FIG. 3 is a diagram showing the relationship between the logic values of gradation selection signals D0 to D5 and their inversion signals BD0 to BD5, and a selected gradation voltage;

FIG. 4 is a diagram showing one example of a layout pattern of the gradation voltage selection circuit in FIG. 1;

FIG. 5 is a diagram of a layout pattern of a modification of FIG. 4;

FIG. 6 is a diagram showing one example of a layout pattern corresponding to three adjacent gradation voltage selection circuits;

FIG. 7 is a diagram showing a simulation result of the comparison between the response of an output wiring line DECOUT of the gradation voltage selection circuit comprising the circuit configuration in FIG. 1 and the response of an output wiring line DECOUT of a conventional gradation voltage selection circuit;

FIG. 8 is a circuit diagram showing the internal configuration of a gradation voltage selection circuit according to a second embodiment of the present invention;

FIG. 9 is a circuit diagram showing the internal configuration of a gradation voltage selection circuit according to a third embodiment of the present invention;

FIG. 10 is a diagram showing one example of a layout pattern corresponding to the gradation voltage selection circuit in FIG. 9; and

FIG. 11 is a diagram showing a simulation result of the comparison between the response of an output wiring line DECOUT of the gradation voltage selection circuit comprising the circuit configuration in FIG. 9 and the response of an output wiring line DECOUT of a conventional gradation voltage selection circuit.

### DETAILED DESCRIPTION OF THE INVENTION

Hereinafter, embodiments of the present invention will be described with reference to the drawings.

### First Embodiment

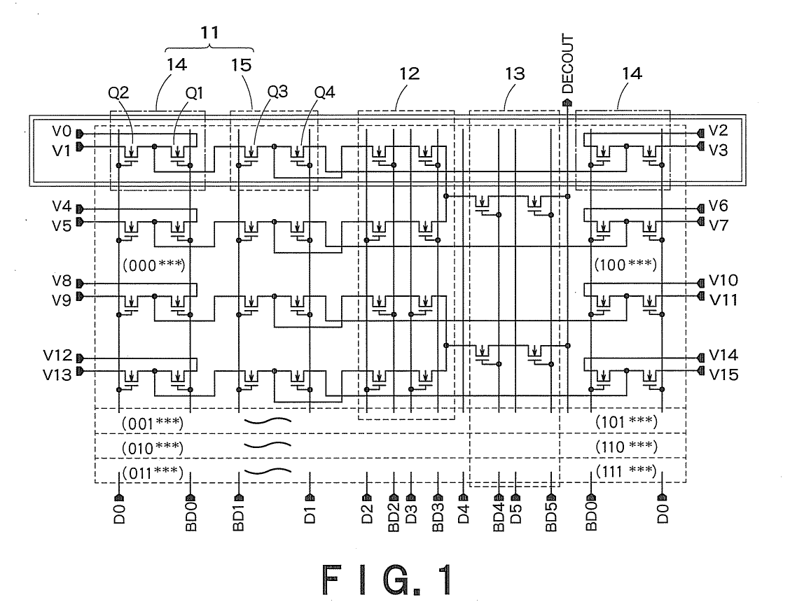

FIG. 1 is a circuit diagram of a gradation voltage selection circuit according to a first embodiment of the present invention. The gradation voltage selection circuit in FIG. 1 is incorporated in, for example, an LCD driver. Before describing the gradation voltage selection circuit in FIG. 1 in detail, the internal configuration of the LCD driver will be first explained.

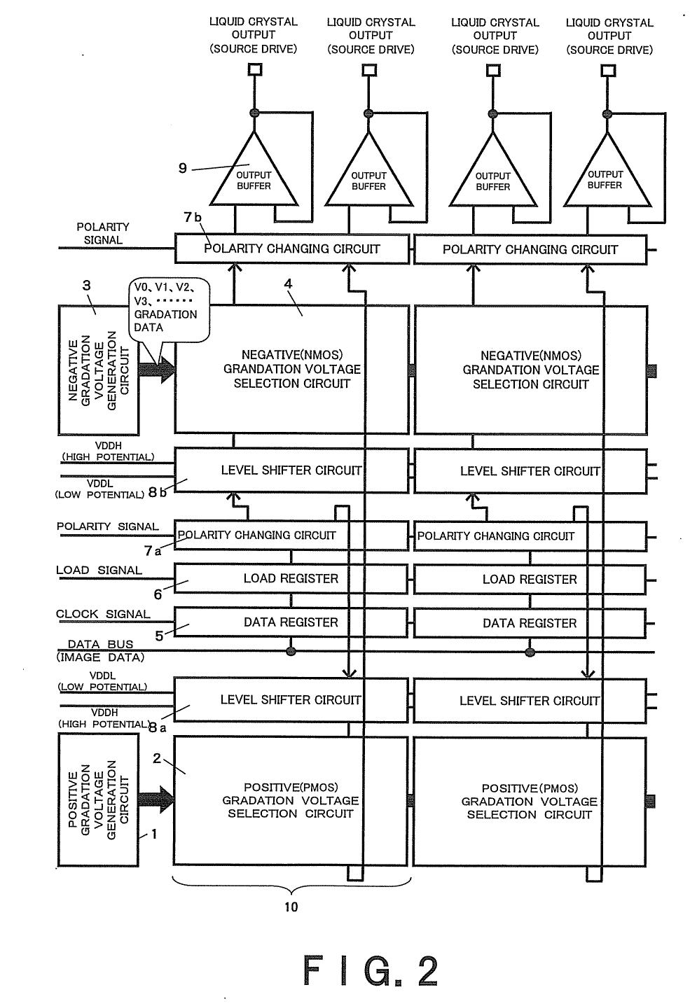

FIG. 2 is a block diagram showing one example of the internal configuration of the LCD driver. The LCD driver in FIG. 2 comprises: a positive gradation voltage generation circuit 1 for generating a plurality of positive gradation voltages; a positive gradation voltage selection circuit 2 for selecting one of the plurality of positive gradation voltages based on the logic of a gradation selection signal; a negative gradation voltage generation circuit 3 for generating a plurality of negative gradation voltages; a negative gradation voltage selection circuit 4 for selecting one of the plurality of negative gradation voltages based on the logic of the gradation selection signal; a data register 5 for latching pixel data to be displayed, synchronously with a clock signal; a load register 6 for latching pixel data for a plurality of pixels synchronously with a load signal; polarity changing circuits 7a, 7b for changing between positive polarity and negative polarity; level shifter circuits 8a, 8b for converting the voltage level of the gradation voltage into a voltage corresponding to the polarity; and an output buffer 9 for adjusting the gain of a selected gradation voltage and then supplying the voltage to a signal line in a liquid crystal panel.

A signal line driving circuit 10 having a set of the positive gradation voltage selection circuit 2, the negative gradation voltage selection circuit 4, the data register 5, the load register 6, the polarity changing circuits 7a, 7b and the level shifter circuits 8a, 8b is provided every two signal lines, and two output buffers 9 are connected to each of the signal line driving circuits 10.

Although only the two signal line driving circuits 10 are shown in FIG. 1, a large number of signal line driving circuits 10 may be actually adjacently arranged. The positive gradation voltage generation circuit 1 and the negative gradation voltage generation circuit 3 are shared by the plurality of signal line driving circuits 10.

The pixel data supplied from a not-shown host computer are sequentially latched pixel by pixel in the data register 5, and then the pixel data for a plurality of pixels are simultaneously latched in the load register 6. The polarity changing circuits 7a, 7b change the polarity of the pixel data by one pixel, by a plurality of pixels, by one horizontal line or by one frame.

The level of the pixel data passed through the polarity changing circuit 7a is adjusted by the level shifter circuits 8a, 8b, such that gradation selection signals are generated. Thus, the gradation selection signals are signals corresponding to the logic of the pixel data.

The positive gradation voltage selection circuit 2 selects one of a plurality of positive gradation voltages based on the logic of the gradation selection signals output from the level shifter circuits 8a, 8b. The negative gradation voltage selection circuit 4 selects one of a plurality of negative gradation voltages based on the logic of the gradation selection signals output from the level shifter circuits 8a, 8b.

The polarity changing circuits 7a, 7b select one of the gradation voltage selected by the positive gradation voltage selection circuit 2 and the gradation voltage selected by the negative gradation voltage selection circuit 4 based on a polarity signal.

Two output buffers 9 are connected to the polarity changing circuit 7b, and each of the output buffers 9 supplies pixel voltages to adjacent two signal lines. For example, in the case of an LCD driver for color display, three output buffers 9 on the left in FIG. 2 supply the pixel voltages to an R signal line, a G signal line and a B signal line of the same pixel, respectively.

In the present embodiment, a plurality of positive gradation voltage selection circuits 2 in a plurality of signal line driving circuits 10 are adjacently arranged, as shown in FIG. 2. The negative gradation voltage selection circuits 4 are also arranged in the same manner. Thus, the positive gradation voltage selection circuits 2 are adjacently arranged in a collective manner, and the negative gradation voltage selection circuits 4 are also adjacently arranged in a collective manner, such that the whole circuit area of the signal line driving circuits 10 can be reduced.

Both of the positive gradation voltage selection circuit 2 and the negative gradation voltage selection circuit 4 are configured by the circuit in FIG. 1. However, the positive gradation voltage selection circuit 2 is different from the negative gradation voltage selection circuit 4 in the conductivity type of the transistors inside the circuit. The positive gradation voltage selection circuit 2 is configured by use of PMOS transistors, while the negative gradation voltage selection circuit 4 is configured by use of NMOS transistors.

While the circuit in FIG. 1 is configured by use of the NMOS transistors, it will hereinafter be simply referred to as a gradation voltage selection circuit. The gradation voltage selection circuit in FIG. 1 comprises: a plurality of gradation selection parts 11 for selecting one of four gradation voltages; a plurality of tournament circuits 12 for repeating operations of selecting one of the two gradation voltages selected by each of the gradation selection parts 11 to finally select one gradation voltage; and a decoder circuit 13 for selecting one of the plurality of gradation voltages selected by the plurality of tournament circuits 12 and supplying the selected one to an output wiring line DECOUT.

Each of the plurality of gradation selection parts 11 has two first switch circuits 14 for selecting one of two kinds of gradation voltages in accordance with the logic of the least significant bit of the gradation selection signal, and a second switch circuit 15 for selecting one of the outputs of the two first switch circuits 14 in accordance with the logic D1 of the second least significant bit of the gradation selection signal and then supplying the selected one to the tournament circuit 12.

The tournament circuit 12 repeats the operation of selecting one of the two gradation voltages in accordance with the logic of bits D2, D3 of the gradation selection signal, and thus selects one of the outputs of the four adjacent second switch circuits 15.

The decoder circuit 13 carries out decode processing in accordance with the logic of bits D4, D5 of the gradation selection signal, and then selects whether to supply the output of the tournament circuit 12 to the output wiring line DECOUT.

Although the circuits for four rows (for sixteen gradations) are only shown in detail in FIG. 1, there are actually circuits for sixteen rows (for 64 gradations). The not-shown circuits for 12 rows are configured in the same manner as the circuits in FIG. 1 except that the circuit configurations in the decoder circuits 13 are different. More specifically, the decoder circuit 13 shown in FIG. 1 reveals a circuit configuration in which the bits D4, D5 of the gradation selection signal decode “0, 0”, in addition to which there are circuits for decoding “0, 1” “1, 0” and “1, 1” in the decoder circuit 13.

One tournament circuit 12 is provided for four second switch circuits 15 adjacent in a row direction (first direction). The decoder circuit 13 selects one of the outputs of four tournament circuits 12 based on the logic of the gradation selection signals D4, D5.

Thus, the entire gradation voltage selection circuit is provided with sixteen gradation selection parts 11, four tournament circuits 12 and one decoder circuit 13. All of the sixteen gradation selection parts 11 are supplied with gradation selection signals D0, D1, all of the four tournament circuits 12 are supplied with the gradation selection signals D2, D3, and the decoder circuit 13 is supplied with the gradation selection signals D4, D5. Thus, the gradation voltage selection circuit in FIG. 1 selects one of a total of 64 gradation voltages V0 to V63 and then supplies the selected one to the output wiring line DECOUT.

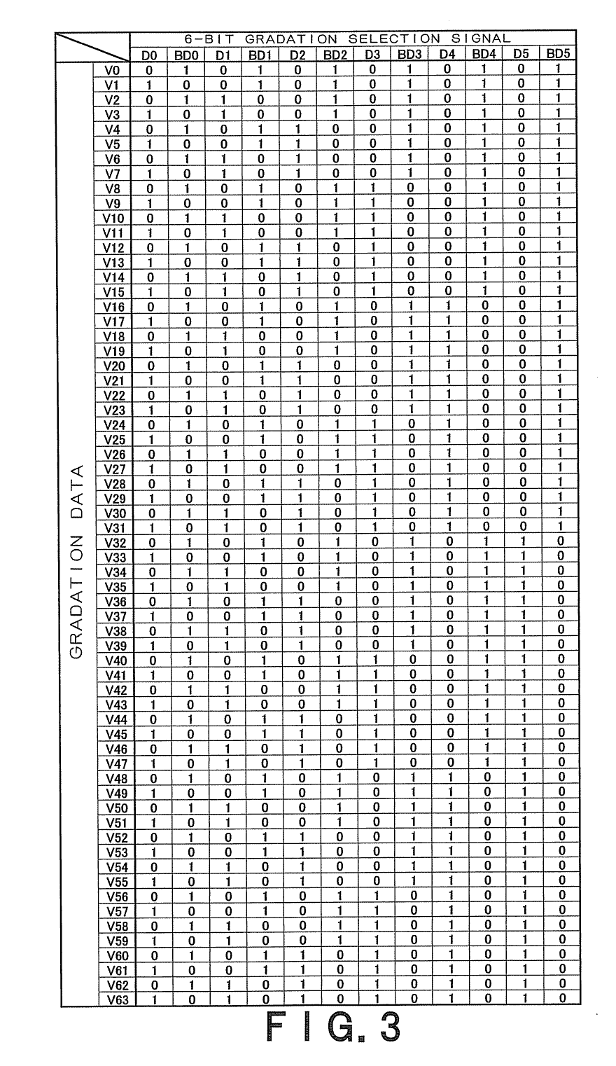

FIG. 3 is a diagram showing a relationship between the logic values of the gradation selection signals D0 to D5 and their inversion signals BD0 to BD5, and a selected gradation voltage. FIG. 3 shows one example, and the correspondence and relationship between the logic value and the gradation voltage can be freely modified as long as they correspond one to one.

The sixteen gradation selection parts 11 are adjacently arranged in the row direction (first direction). The gradation selection part 11 in the first row in FIG. 1 selects one of the gradation voltages V0 to V3. The gradation selection part 11 in the second row selects one of the gradation voltages V4 to V7, the gradation selection part 11 in the third row selects one of the gradation voltages V8 to V11, and the gradation selection part 11 in the fourth row selects one of the gradation voltages V12 to V15. Although not shown in FIG. 2, the gradation selection part 11 in the last row selects one of the gradation voltages V60 to V63.

While the gradation selection part 11, the tournament circuit 12 and the decoder circuit 13 in the gradation voltage selection circuit are configured by use of the NMOS transistors or PMOS transistors, they are hereinafter simply described as transistors.

The first switch circuit 14 in the gradation selection part 11 selects one of two kinds of gradation voltages in accordance with the logic of the least significant bit D0 of the gradation selection signal. The first switch circuit 14 has two transistors Q1, Q2. The inversion signal BD0 of the least significant bit is input to the gate of the transistor Q1, and the least significant bit D0 is input to the gate of the transistor Q2. The transistor Q1 is turned on when the least significant bit BD0 is “1”, and thus supplies the gradation voltage V0 to an output terminal. The transistor Q2 is turned on when the least significant bit D0 is “1”, and thus supplies the gradation voltage V1 to an output terminal.

For example, the first switch circuit 14 at the left end in the gradation selection part 11 of the first row selects one of the gradation voltages V0, V1 in accordance with the logic of the least significant bit D0, and the first switch circuit 14 at the right end selects one of the gradation voltages V2, V3 in accordance with the logic of the least significant bit D0.

The second switch circuit 15 in the gradation selection part 11 selects one of the outputs of the two first switch circuits 14 on both sides in accordance with the logic of the second least significant bit D1 of the gradation selection signal. The second switch circuit 15 has two transistors Q3, Q4. The inversion signal BD1 of the second least significant bit is input to the gate of the transistor Q3, and the second least significant bit D1 is input to the gate of the transistor Q4. If the second least significant bit D1 is “0”, the transistor Q3 is turned on, and the output of the left first switch circuit 14 is output from the second switch circuit 15. If the second least significant bit D1 is “1”, the output of the right first switch circuit 14 is output from the second switch circuit 15.

The tournament circuit 12 selects one of the two outputs in the form of a tournament out of the outputs of the four second switch circuits 15 adjacent in the row direction based on the logic of the third least significant bit D2 and fourth least significant bit D3 of the gradation selection signal. More specifically, one of the outputs of the second switch circuit 15 in the odd line and the second switch circuits 15 in the even line is selected based on the logic of the third least significant bit D2 of the gradation selection signal. Moreover, one of adjacent two rows is selected based on the logic of the fourth least significant bit D3. Thus, the gradation voltages are narrowed down to four candidates in the entire gradation voltage selection circuit.

The decoder circuit 13 selects one of the four gradation voltages output from the tournament circuit 12, based on the result of decoding the remaining two bits D4, D5 of the gradation selection signal.

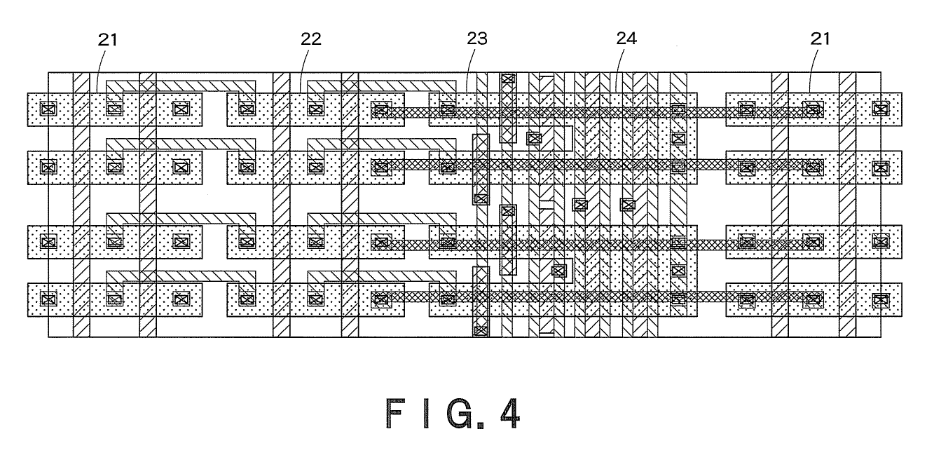

FIG. 4 is a diagram showing one example of a layout pattern of the gradation voltage selection circuit in FIG. 1. FIG. 4 shows the layout pattern corresponding to the gradation selection parts 11 of four rows. Sequentially formed in a lateral direction (second direction) are diffusion layers 21, 22 for the first and second switch circuits 14, 15 in each of the gradation selection parts 11, a diffusion layer 23 for the tournament circuit 12 and the decoder circuit 13, and a diffusion layer 21 for the first switch circuit 14. Moreover, wiring lines of the gradation selection signals D0 to D5 and BD0 to BD5 are formed in a longitudinal direction (first direction). Each wiring layers for the gradation selection signals D0 to D5 and BD0 to BD5 are formed above the diffusion layers 21 to 24, respectively.

The diffusion layer 23 of the tournament circuit 12 and the diffusion layer 24 for the decoder circuit 13 are combined into one, and the width of the diffusion layer 23 closer to the output wiring line DECOUT disposed on the right is larger. The reason that the diffusion layer 23 on the side of the output wiring line DECOUT can be larger is that the decoder circuits 13 in the adjacent gradation selection parts 11 for two rows output the same decoded value and the diffusion layer 23 can therefore be shared.

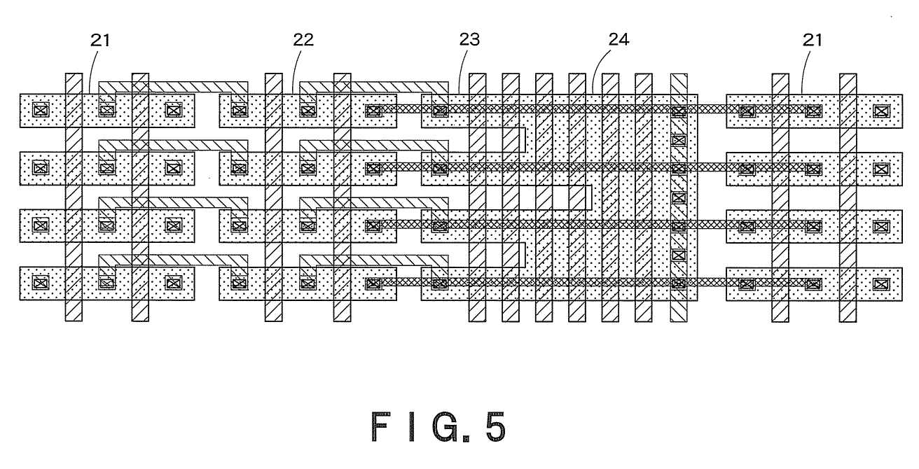

FIG. 5 is a diagram of a layout pattern of a modification of FIG. 4, wherein the diffusion layers 23 of the decoder circuits 13 in the adjacent gradation selection parts 11 for four rows are combined into one. FIG. 5 can reduce more parasitic capacitance of the decoder circuits 13 than FIG. 4.

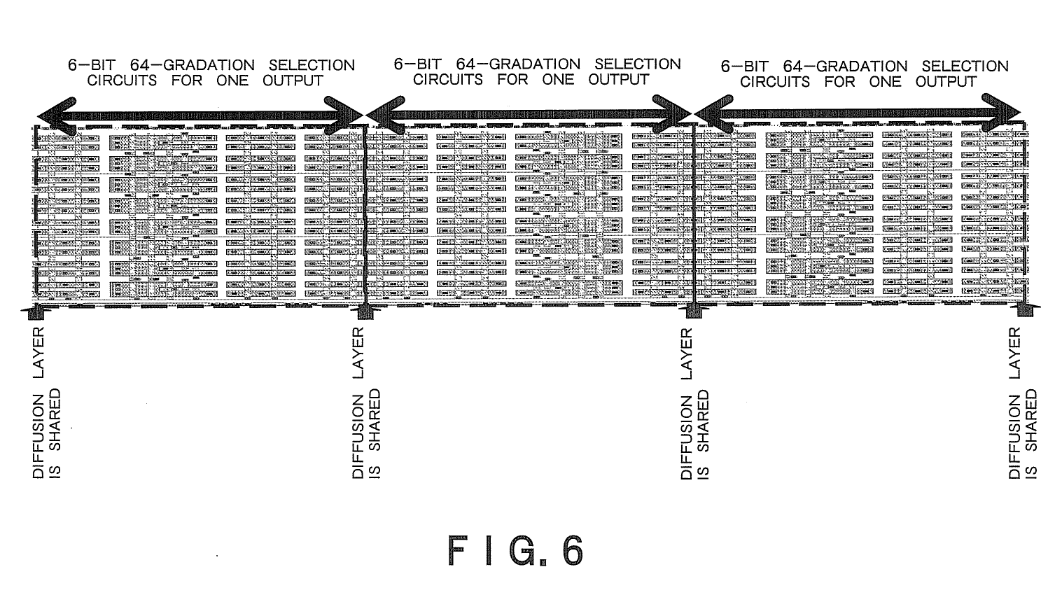

FIG. 6 is a diagram showing one example of a layout pattern corresponding to three adjacent gradation voltage selection circuits, wherein the three gradation voltage selection circuits are adjacently arranged in the lateral direction. Each of the gradation voltage selection circuits in FIG. 6 has the same layout pattern as that in FIG. 4, and the diffusion layer on the boundary between the gradation voltage selection circuits is shared. More specifically, the diffusion layer 21 in the first switch circuit 14 is shared. Thus, the gradation voltage selection circuits share the diffusion layer 21 on the boundary, such that the area of the circuits can be reduced.

Although three gradation voltage selection circuits are shown in FIG. 6, several hundred (e.g., 360) gradation voltage selection circuits are actually adjacently arranged in the lateral direction, so that the diffusion layers on the boundaries are shared by the gradation voltage selection circuits, thereby allowing a significant reduction of the circuit area.

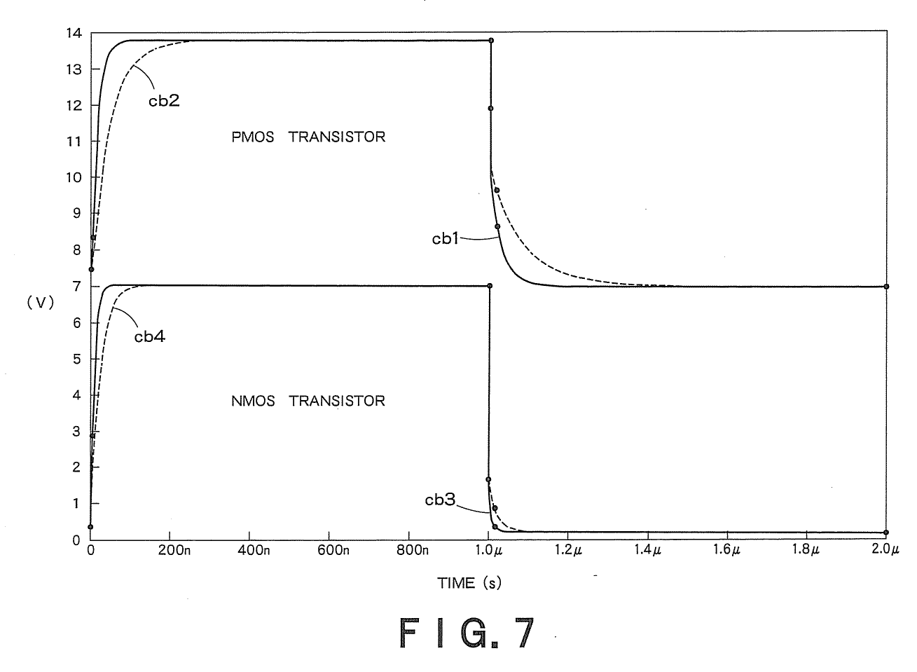

FIG. 7 is a diagram showing a simulation result of the comparison between the response of the output wiring line DECOUT of the gradation voltage selection circuit comprising the circuit configuration in FIG. 1 and the response of an output wiring line DECOUT of a conventional gradation voltage selection circuit. FIG. 7 shows response characteristic curves cb1, cb2 of the positive gradation voltage selection circuit 2 configured by the PMOS transistors and response characteristic curves cb3, cb4 of the negative gradation voltage selection circuit 4 configured by the NMOS transistors. The full curves cb1, cb3 in FIG. 7 indicate response characteristics of the present embodiment, and the dashed curves cb2, cb4 indicate conventional response characteristics.

As apparent from FIG. 7, the rising edge and falling edge of a signal waveform of the output wiring line DECOUT are steeper in the present embodiment than in the conventional case. This is conceivably due to the fact that the parasitic capacitance of the decoder circuits 13 is reduced because the size of the decoder circuit 13 is smaller in the present embodiment than in the conventional case and that as the channel width of the transistor closer to the output wiring line DECOUT is larger, the on-resistance of this transistor is reduced and the roundness of the signal supplied to the output wiring line DECOUT is suppressed such that high-velocity response is enabled.

Thus, in the first embodiment, a plurality of gradation selection parts 11 which provide four selectable gradations are arranged in the row direction, and two first switch circuits 14 in each of the gradation selection parts 11 are laterally separately arranged, and then the second switch circuit 15, the tournament circuit 12 and the decoder circuit 13 are arranged between the two first switch circuits 14, such that the size of the decoder circuit 13 can be reduced, and the parasitic capacitance of the output wiring line DECOUT connected to the decoder circuit 13 can be drastically reduced. Moreover, the width of the diffusion layer closer to the output wiring line DECOUT can be increased, and the channel width of the transistors in the decoder circuit 13 can be increased, so that the switching operation of the transistors can be faster. This improves the operation velocity of the gradation voltage selection circuit.

While the gradation selection signals D2, D3 are supplied to the tournament circuit 12 and the gradation selection signals D4, D5 are supplied to the decoder circuit 13 in the first embodiment described above, the bits supplied to the tournament circuit 12 and the bits supplied to the decoder circuit 13 can be arbitrarily changed. Actually, it is desirable to allocate the bits of the gradation selection signals to the tournament circuit 12 and the decoder circuit 13 so that the total area of the circuits 12, 13 may be smaller.

### Second Embodiment

In the first embodiment, the example has been described wherein the second switch circuit 15 selects one of the outputs of two first switch circuits 14 based on the logic of the second least significant bit D1 of the gradation selection signal. In a second embodiment described below, a second switch circuit 15 selects one of the outputs of two first switch circuits 14 based on the logic of a most significant bit D5 of a gradation selection signal.

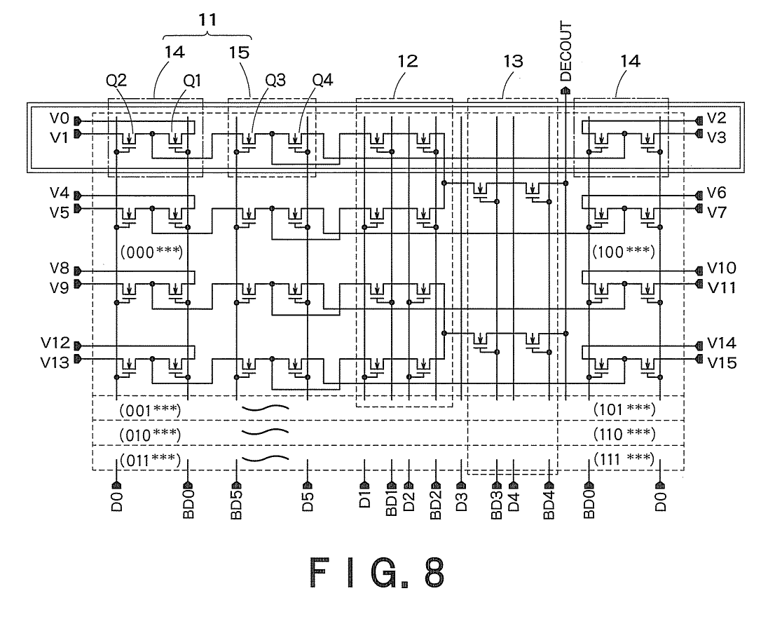

FIG. 8 is a circuit diagram showing the internal configuration of a gradation voltage selection circuit according to the second embodiment of the present invention. The basic circuit configuration in FIG. 8 is similar to that in FIG. 1, but the kind of gradation selection signals supplied to the second switch circuit 15, a tournament circuit 12 and a decoder circuit 13 is different. Gradation selection signals D5, BD5 are supplied to the second switch circuit 15 in FIG. 8, gradation selection signals D1, BD1, D2, BD2 are supplied to the tournament circuit 12, and gradation selection signals D3, BD3, D4, BD4 are supplied to the decoder circuit 13.

The circuit in FIG. 8 can also be formed by a layout pattern similar to that in FIG. 4, and makes it possible to obtain effects similar to those in the first embodiment.

In the second embodiment as well, the bits of the gradation selection signals supplied the tournament circuit 12 and the decoder circuit 13 can be arbitrarily changed.

### Third Embodiment

While the examples have been described in the first and second embodiments wherein the 6-bit gradation selection signals are used to output a gradation voltage with 64 gradations, 8-bit gradation selection signals are used to output a gradation voltage with 256 gradations in a third embodiment described below.

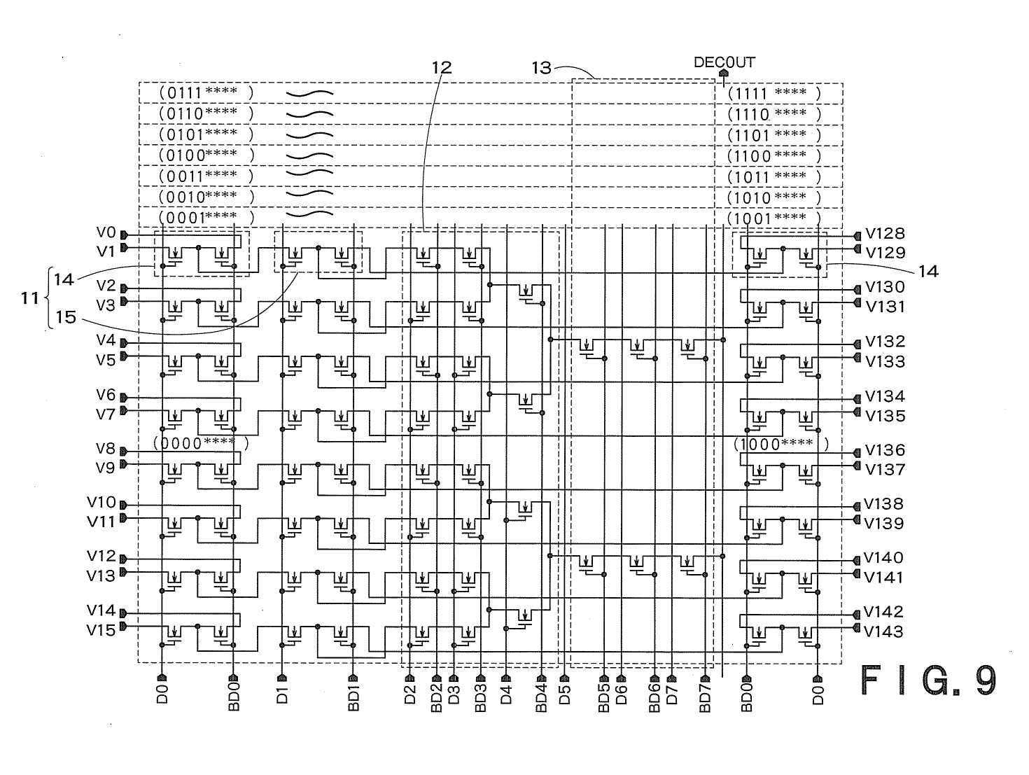

FIG. 9 is a circuit diagram showing the internal configuration of a gradation voltage selection circuit according to the third embodiment of the present invention. The gradation voltage selection circuit in FIG. 9 has 64 gradation selection parts 11 arranged in a row direction, 8 tournament circuits 12 and one decoder circuit 13. Each of the gradation selection parts 11 has two first switch circuits 14 arranged on both sides and a second switch circuit 15, as in the first and second embodiments.

Each of the two first switch circuits 14 selects one of two kinds of gradation voltages based on the logic of a gradation selection signal D0. The second switch circuit 15 selects one of the outputs of the two first switch circuits 14 based on the logic of a gradation selection signal D1. The tournament circuit 12 sequentially selects one of the two outputs out of the outputs of the 8 second switch circuits 15 based on the logic of gradation selection signals D2 to D4. Finally, the tournament circuit 12 selects eight kinds of gradation voltage candidates in the entire gradation voltage selection circuit. The decoder circuit 13 supplies a final gradation voltage to an output wiring line DECOUT based on the result of being decoded in accordance with the logic of gradation selection signals D5 to D7.

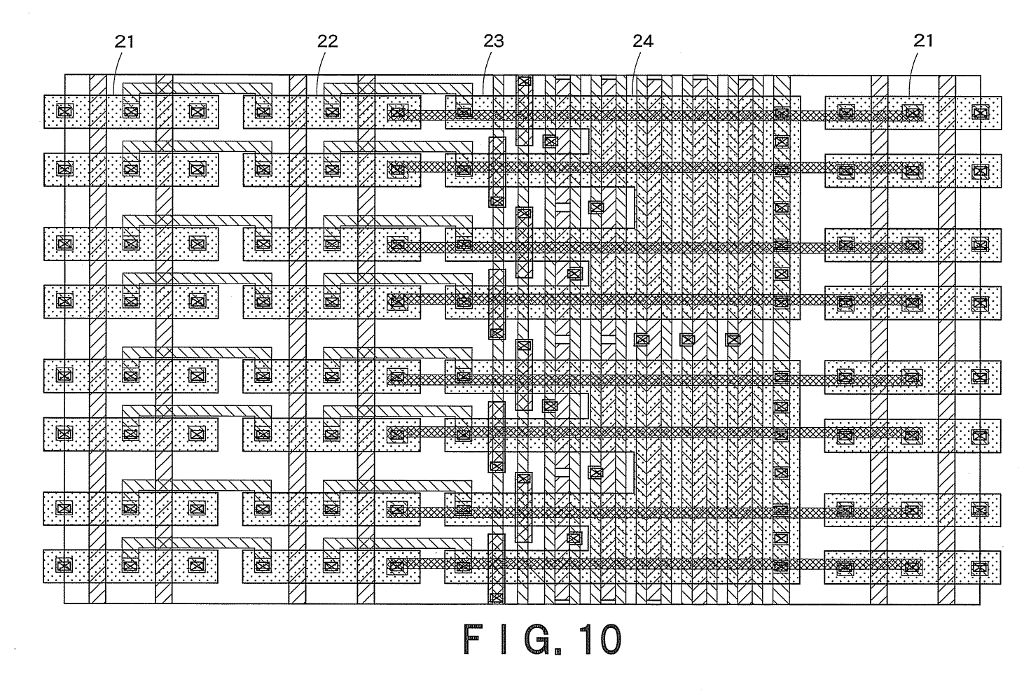

FIG. 10 is a diagram showing one example of a layout pattern corresponding to the gradation voltage selection circuit in FIG. 9. As shown, the 64 gradation selection parts 11 are adjacently arranged in a longitudinal direction (first direction), and the first switch circuits 14, the second switch circuit 15, the tournament circuit 12 and the decoder circuit 13 in each of the gradation selection parts 11 are sequentially arranged in a lateral direction (second direction). A diffusion layer 23 of the tournament circuit 12 is connected to a diffusion layer 24 of the decoder circuit 13, and the diffusion layer 24 of the decoder circuit 13 is shared by a plurality of rows.

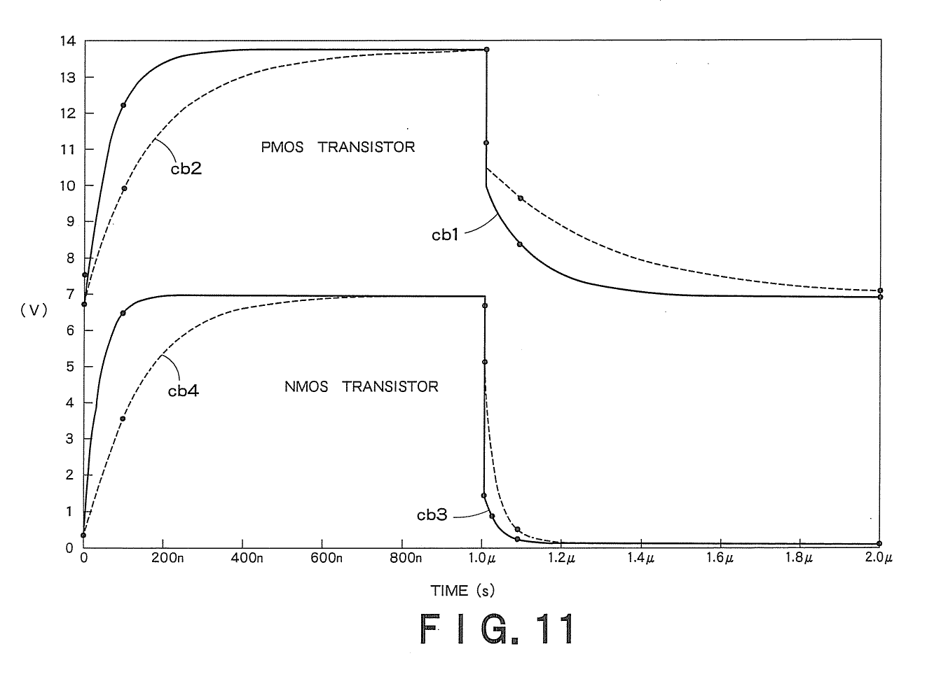

FIG. 11 is a diagram showing a simulation result of the comparison between the response of the output wiring line DECOUT of the gradation voltage selection circuit comprising the circuit configuration in FIG. 9 and the response of an output wiring line DECOUT of a conventional gradation voltage selection circuit. FIG. 11 shows response characteristic curves cb1, cb2 of the positive gradation voltage selection circuit 2 configured by the PMOS transistors and response characteristic curves cb3, cb4 of the negative gradation voltage selection circuit 4 configured by the NMOS transistors. The full curves cb1, cb3 in FIG. 11 indicate response characteristics of the present embodiment, and the dashed curves cb2, cb4 indicate conventional response characteristics.

As apparent from the comparison between FIG. 11 and FIG. 7, the roundness of a waveform is greater because the circuit in FIG. 9 has more transistors and thus more parasitic capacitance than the circuit in FIG. 1, but the rising edge and falling edge of a signal are much steeper than those of the conventional signal waveform.

Thus, in the third embodiment, it is also possible to reduce the parasitic capacitance of the output wiring line DECOUT and improve the operation velocity of the gradation voltage selection circuit as in the first and second embodiments.

While the second least significant bit D1 of the gradation selection signal is supplied to the second switch circuit 15 in the third embodiment, the most significant bit may be supplied instead as in the second embodiment. Moreover, in the third embodiment as well, the gradation selection signals supplied the tournament circuit 12 and the decoder circuit 13 can be freely changed, and it is desirable to allocate the bits so that the area of the circuits may be smaller.

What is claimed is:

1. A gradation voltage selection circuit, comprising:
a plurality of gradation selection parts configured to select one of four kinds of gradation voltages, respectively;
a plurality of tournament circuits configured to repeat operations of selecting one of two gradation voltages selected by the gradation selection parts to select one gradation voltage, respectively; and
a decoder circuit configured to select one of the plurality of gradation voltages selected by the plurality of tournament circuits and to supply the selected one to an output wiring line,
each of the plurality of gradation selection parts including:
two first switch circuits configured to select one of two kinds of gradation voltages based on the least significant bit of a gradation selection signal; and
a second switch circuit configured to select one of outputs of the two first switch circuits in accordance with a logic of the most significant bit or the second least significant bit of the gradation selection signal and to supply the selected one to the tournament circuit,
the tournament circuit repeating operations of selecting one of two gradation selection voltages based on a logic of partial bits except for bits of the gradation selection signal used for selection operations of the first and second switch circuits; and
the decoder circuit selecting one of the plurality of gradation voltages output from the tournament circuit based on a result of decoding bits except for bits of the gradation selection signal used for selection operations of the first switch circuit, second switch circuit and tournament circuit, and supplying the selected one to the output wiring line.

2. The gradation voltage selection circuit according to claim 1, wherein:
the plurality of gradation selection parts is adjacently arranged in a first direction;
the second switch circuit, tournament circuit and decoder circuit are adjacently arranged in a second direction different from the first direction; and
the two first switch circuits are arranged on both sides in the second direction by sandwiching the adjacently arranged second switch circuit, tournament circuit and decoder circuit.

3. The gradation voltage selection circuit according to claim 1, wherein:
one tournament circuit is provided for two or more of the first and second switch circuits adjacently arranged in the first direction; and
one decoder circuit is provided for the plurality of gradation selection parts.

4. The gradation voltage selection circuit according to claim 1, wherein:
the two first switch circuits have a first diffusion layers extended in the second direction;
the second switch circuit has a second diffusion layer extended in the second direction;
the tournament circuit has a plurality of third diffusion layers extended in the second direction;
the decoder circuit has a fourth diffusion layer extended in the first and second directions; and
a plurality of wiring layers for the gradation selection signal are disposed along the first direction above the first to fourth diffusion layers.

5. The gradation voltage selection circuit according to claim 4, wherein two of the third diffusion layers adjacently disposed in the first direction are connected to the same fourth diffusion layer.

6. The gradation voltage selection circuit according to claim 4, wherein four or more of the third diffusion layers adjacently disposed in the first direction are connected to the same fourth diffusion layer.

7. The gradation voltage selection circuit according to claim 4, further comprising a wiring layer for the output wiring line which is formed above the fourth diffusion layer, an area of the fourth diffusion layer being greater at a side nearer to the wiring layer for the output wiring line.

8. The gradation voltage selection circuit according to claim 4, wherein:
a plurality of groups are provided in the second direction, each group including the plurality of gradation selection parts arranged in the first direction; and
the adjacent two first switch circuits in the adjacent groups share the first diffusion layer.

9. The gradation voltage selection circuit according to claim 1, wherein bits different from each other of the gradation selection signal are distributed to the tournament circuit and the decoder circuit so that total area of the tournament circuit and the decoder circuit becomes minimum.

10. A display control circuit, comprising:
a positive gradation voltage selection circuit configured to generate a positive gradation voltage;
a negative gradation voltage selection circuit configured to generate a negative gradation voltage;
a polarity changing circuit configured to select one of the positive gradation voltage and negative gradation voltage; and
an output circuit configured to adjust a gain of the gradation voltage selected by the polarity changing circuit and supply the adjusted voltage to the corresponding signal line,
each of the positive polarity gradation voltage selection circuit and negative gradation voltage selection circuit including:
a plurality of gradation selection parts configured to select one of four kinds of gradation voltages, respectively;
a plurality of tournament circuits configured to repeat operations of selecting one of two gradation voltages selected by the gradation selection parts to select one gradation voltage, respectively; and
a decoder circuit configured to select one of the plurality of gradation voltages selected by the plurality of tournament circuits and to supply the selected one to an output wiring line,
each of the plurality of gradation selection parts including:
two first switch circuits configured to select one of two kinds of gradation voltages based on the least significant bit of a gradation selection signal; and
a second switch circuit configured to select one of outputs of the two first switch circuits in accordance with a logic of the most significant bit or the second least significant bit of the gradation selection signal and to supply the selected one to the tournament circuit,
the tournament circuit repeating operations of selecting one of two gradation selection voltages based on a logic of partial bits except for bits of the gradation selection signal used for selection operations of the first and second switch circuits; and
the decoder circuit selecting one of the plurality of gradation voltages output from the tournament circuit based on a result of decoding bits except for bits of the gradation selection signal used for selection operations of the first switch circuit, second switch circuit and tournament circuit, and supplying the selected one to the output wiring line.

11. The display control circuit according to claim 10, wherein:
the plurality of gradation selection parts are adjacently arranged in a first direction;
the second switch circuit, tournament circuit and decoder circuit are adjacently arranged in a second direction different from the first direction; and
the two first switch circuits are arranged on both sides in the second direction by sandwiching the adjacently arranged second switch circuit, tournament circuit and decoder circuit.

12. The display control circuit according to claim 11, wherein:
one tournament circuit is provided for two or more of the first and second switch circuits adjacently arranged in the first direction; and
one decoder circuit is provided for the plurality of gradation selection parts.

13. The display control circuit according to claim 11, wherein:
the two first switch circuits have a first diffusion layers extended in the second direction;
the second switch circuit has a second diffusion layer extended in the second direction;
the tournament circuit has a plurality of third diffusion layers extended in the second direction;
the decoder circuit has a fourth diffusion layer extended in the first and second directions; and
a plurality of wiring layers for the gradation selection signal are disposed along the first direction above the first to fourth diffusion layers.

14. The display control circuit according to claim 13, wherein two of the third diffusion layers adjacently disposed in the first direction are connected to the same fourth diffusion layer.

15. The display control circuit according to claim 14, wherein four or more of the third diffusion layers adjacently disposed in the first direction are connected to the same fourth diffusion layer.

16. The display control circuit according to claim 13, further comprising a wiring layer for the output wiring line which is formed above the fourth diffusion layer, an area of the fourth diffusion layer being greater at a side nearer to the wiring layer for the output wiring line.

17. The display control circuit according to claim 13, wherein:
a plurality of groups are provided in the second direction, each group including the plurality of gradation selection parts arranged in the first direction; and
the adjacent two first switch circuits in the adjacent groups share the first diffusion layer.

18. The display control circuit according to claim 10, wherein bits different from each other of the gradation selection signal are distributed to the tournament circuit and the decoder circuit so that total area of the tournament circuit and the decoder circuit becomes minimum.
